(19) United States
(12) Patent Application Publication
(10) Pub. No.: US 2002/0185976 A1
(43) Pub. Date: Dec. 12, 2002

(54) Lamp assemblies with compensating rings between lamp bodies and output windows with different rates of thermal expansion

(76) Inventors: T. Lyle Brady, Alta Loma, CA (US); James F. Weaver, Monrovia, CA (US); Steven H. Boland, Glendora, CA (US)

Correspondence Address: Boniard I. Brown, 1500 West Covina Parkway, #113, West Covina, CA, 91790-2793, US

(21) Appl. No.: 09/877,448

(22) Filed: Jun. 11, 2001

(51) Int. Cl. H01J 17/18; H01J 61/36

(52) U.S. Cl. 313/631

(57) ABSTRACT

A ring mounted by sealant between a lamp body and an output window has a coefficient of thermal expansion intermediate to those of the lamp body and output window, thus to compensate for differing rates of thermal expansion and contraction of the lamp body and output window. A ring may be of solid metallic material, and may be solid or adapted to flex between the body and window.

### BACKGROUND AND SUMMARY OF THE INVENTION

The present invention relates to the provision of sealed connections between components formed of two dissimilar materials having different coefficients of thermal expansion and contraction.

The invention is particularly applicable to the provision of vacuum-tight sealing between a lamp housing and an output window, while accommodating thermal expansion and contraction as between the lamp body and the window. Rings, herein called expansion rings, are utilized between lamp bodies and output windows of different respective materials. A flexible ring or a solid ring may be utilized between two members, such as a lamp body and an output window, the materials of which may have widely different coefficients of thermal expansion and contraction. Many dissimilar materials cannot be directly bonded.

As an example, a zinc selenide window cannot be bonded directly to an Inconel lamp body. The two materials have widely different coefficients of expansion, and the members must be joined without compromising the integrity and strength of the sealing therebetween.

The present invention provides for interconnection of lamp bodies and output windows, utilizing a ring between the output window and the lamp body and bonded to each. With a window of zinc selenide, for example, a preferred window material, and an end portion of the lamp body formed of alumina or ceramic material, a ring may be connected with a sealant therebetween comprising solder, a braze, glass frit, or epoxy. Where solder or braze are used, an end portion of the lamp body and peripheral or edge portion of the window are preferably metallized prior to brazing or soldering.

The rings of FIGS. 2 to 5 are adapted by their thickness to flex to accommodate relative movement between the window and the lamp body.

### BRIEF DESCRIPTION OF THE DRAWINGS

FIG. 1 is a perspective view of a lamp having a body and an output window joined by an expansion loop ring;

FIG. 2 is a sectional view taken at line 2-2 in FIG. 1, showing an end portion of a lamp body and an output window joined by a loop ring;

FIG. 3 is a sectional view of a modified form of the invention wherein an output window is joined by a loop ring and extends outwardly of the end portion of the lamp body;

FIG. 4 shows a modified form of the invention wherein a loop ring has two convolutions and joins a lamp body end portion and an output window disposed outwardly of the lamp body end portion;

FIG. 4A shows a form of the invention wherein a loop ring of generally rectilinear cross-section is bonded to the output window and to the lamp body, and the window is disposed inwardly of the lamp body end;

FIG. 5 shows an embodiment wherein a loop ring has two convolutions and an output window is disposed outwardly of the end of a lamp body;

FIGS. 6 and 7 show an embodiment of the invention wherein a ring has two parts bonded together and bonded to the window and the lamp body;

FIG. 8 shows a solid ring disposed between an output window and an end portion of a lamp body; and

FIG. 9 shows an embodiment similar to that of FIG. 8 wherein a solid metal ring is mounted to a window and to a lamp body by glass frit.

### DESCRIPTION OF THE PREFERRED EMBODIMENTS

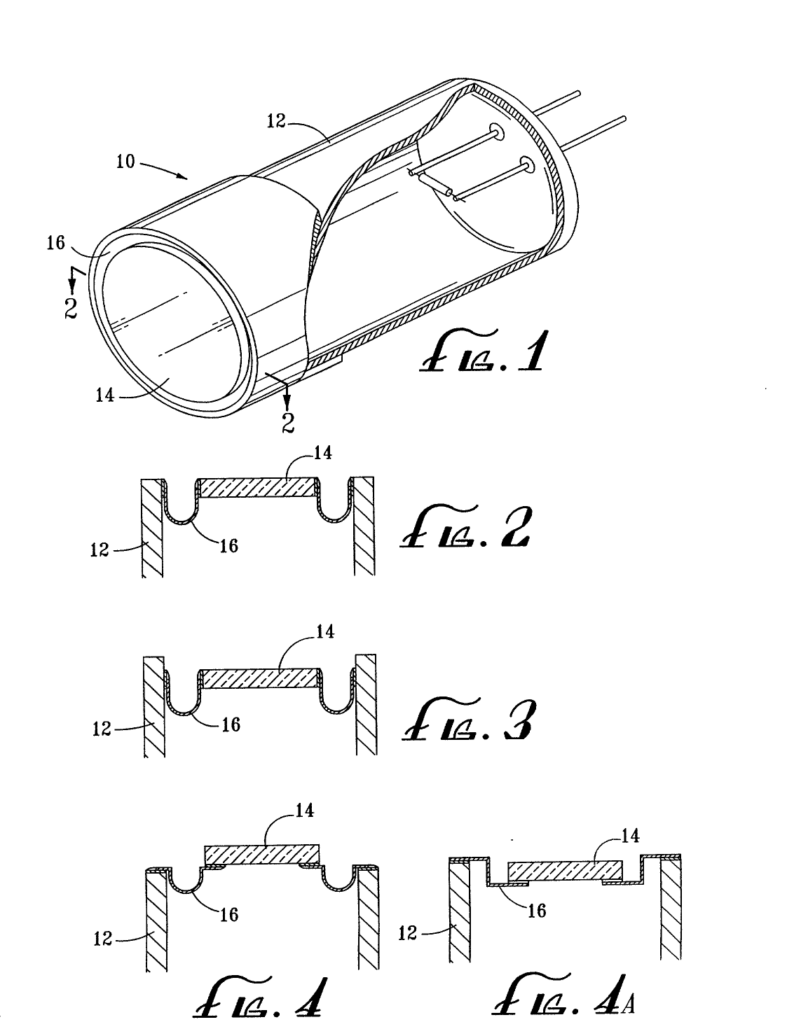

Referring to the drawings, FIG. 2 is a sectional view taken at line 2-2 in FIG. 1, showing a lamp 10 having a body 12 and an output window 14. Between the edge or periphery of the window and an end portion of the output window 14 there extends a ring 16, which is bonded to each of these members. With the lamp body formed of aluminum oxide or ceramic, and an output window formed of zinc selenide, the materials cannot be bonded to each other. The ring may be bonded to the lamp body and the window by solder, braze, glass frit, or epoxy, depending upon which is appropriate for particular degrees of temperature change, etc. If soldering or brazing is utilized, the portions of the window and of the lamp body are metallized before brazing or soldering. The rings of a loop configuration are in cross-section, as shown, thus to accommodate relative movement between the window and the lamp body with temperature changes.

The lamp body edge portion is connected with the output window without compromising the integrity of the seals therebetween, despite widely different thermal expansion coefficients of these members, and vacuum-tight sealing is provided.

FIG. 3 illustrates a form of the invention similar to that of FIG. 2, but wherein the output window is disposed within the outer edge of the lamp body by the bonding of the loop in a lower position in the lamp body, as shown.

FIG. 4 illustrates an embodiment similar to that of FIG. 2 but which differs in that the loop is bonded to the end edge surface of the ring, and is configurated to maintain a window outwardly of the end edge of the lamp body.

FIG. 4A is an embodiment similar to that of FIG. 2 but differing therefrom in that a ring of generally rectilinear cross-section is bonded to the lower edge portion of the window.

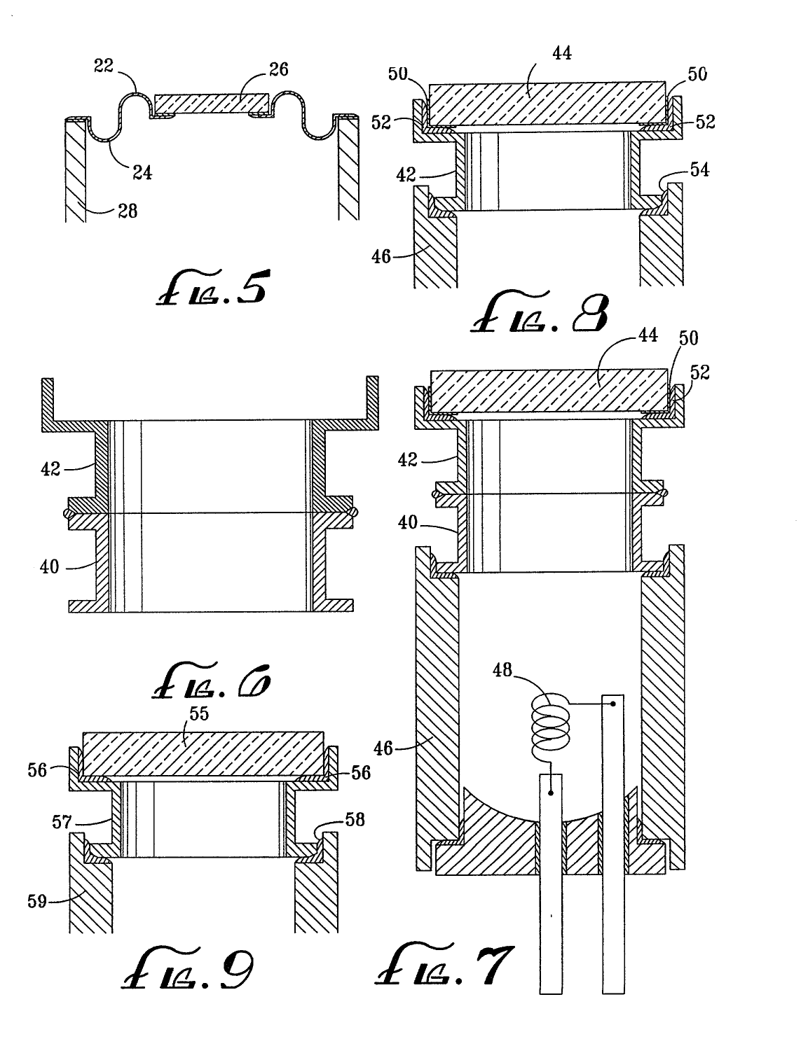

FIG. 5 illustrates an embodiment similar to that of FIG. 4, except that a ring has a cross-sectional configuration having two loops 22, 24, instead of the single loop of FIG. 4, thus to provide a greater degree of compensation for relative movement between the window and the lamp body with temperature variation.

The rings of FIGS. 2 to 5 are adapted by their thickness to flex to accommodate relative movement between the window and the lamp body.

Preferred ring materials for some embodiments are Kovar, Invar, Invar alloys, and other appropriate metals, thus to provide appropriate relative thermal expansion, as between the ring, output window, and lamp body.

Utilizing a zinc selenide output window and an alumina lamp body, a preferred ring material is an alloy of Invar of which a number of different alloys are available.

It may be noted that where a sapphire output window and aluminum oxide lamp body are utilized, no ring is needed, because the coefficient of thermal expansion of these materials are compatible.

FIGS. 6 and 7 illustrate an embodiment of the invention wherein a solid half-ring 40 of Kovar and a solid half-ring 42 of Invar or Invar alloy, are bonded between a zinc selenide window 44 and a ceramic lamp body 46 having a filament 48 therein. The output window is bonded to ring 42, the lamp body is bonded to the ring 40, and the two rings are bonded together, as shown. A machined Kovar or Invar ring are preferred types of rings and may be fabricated by forming or spinning. The ring is disposed between the body and the output window. The lamp body and an edge portion of the window are first metallized, and the two materials are soldered or brazed together. In FIG. 8, metallizing of window 44 is indicated at 50, a braze or solder is indicated at 52, and braze or solder is indicated at 54.

In FIG. 9, a window 55 is bonded to a metal ring 57 by glass frit 56, and the metal ring is sealed to a body 59 by glass frit 58.

The rings have radially extending spaced-apart flanges for bonding to the window and to the lamp body end portion, as shown.

The thickness of a metal expansion ring is somewhat critical. It is governed and dependent upon the overall expansion and contraction rate, as between a lamp body and a window and the tensile strength of the respective materials. A window of low-tensile strength requires a sufficiently thin metal ring that the metal thereof can expand and contract a required amount without stressing the material of the window to a breaking point. Conversely, with a lamp body of high tensile strength and the window of low tensile strength, the stress of the lamp body must not be transferred to and exceed the breaking point of the window material.

The zine selenide window is bonded to the Invar ring, the window being quite incompatible with a ceramic lamp body. The two metal rings of Kovar and Invar, are utilized because of the coefficients of thermal expansion of Kovar is intermediate between the expansion rates of the Invar ring and the alumina of the lamp body, and the Invar ring has a thermal expansion rate between that of Kovar and the zinc selenide window. The Kovar ring may be bonded, inter alia, by a glass frit coating or by the metallizing of alumina and the brazing of the Kovar ring to the alumina.

A preferred arrangement comprises the bonding of the zinc selenide to the Invar, and the bonding of the Invar to the aluminum oxide lamp body.

To provide the required vacuum-tight seal the sealant materials must be hermetic, and involve no long-term gas diffusion via the sealant material itself.

Certain epoxies may be utilized as a sealant, depending upon the amount of gas-fusion or out-gassing thereof under vacuum, as well as upon differential thermal expansion as between the bonded materials.

A zinc selenide window may be bonded to an Invar ring by a glass frit, or a low-temperature braze can join the window to an Invar ring. A glass frit must be capable of bonding to the Kovar ring, the window, and the lamp body.

Glass frit is a preferred sealant because it provides a smooth, uniform surface. The glass frit utilized as a sealant must have appropriate expansion and contraction characteristics to provide bonding and sealing between the ring, typically of Invar, and an output window and lamp body.

A variety of expansion rings may be utilized between lamp bodies and output windows of different materials. A variety of flexible and solid rings may be utilized between two members of widely different coefficients of thermal expansion and contraction.

The present invention is applicable to a wide variety of combinations of materials, provided such materials have the capabilities of withstanding brazing and/or glass frit sealing temperatures. The materials of widely different thermal expansion and contraction rates can be joined and sealed.

It will be understood that various changes and modifications may be made from the preferred embodiments discussed above without departing from the scope of the present invention, which is established by the following claims and equivalents thereof.

The inventors claim:

1. A lamp assembly having a lamp body and an output window having different coefficients of thermal expansion and contraction, said lamp assembly comprising:
at least one ring comprising material secured between an end portion of the lamp body and a peripheral portion of the output window,
said at least one ring comprising at least one material having a coefficient of expansion between the coefficient of expansion of the lamp body and the output window to provide sealing between the output window and the lamp body with temperature changes, and
a sealant between the lamp body and the output window and a sealant between the ring and the lamp body,
whereby the coefficient of expansion of said at least one ring compensates for differing thermal expansion and contraction rates of the output window and the lamp body to provide vacuum-tight sealing therebetween.

2. A lamp assembly according to claim 1, wherein said lamp body is hollow and said output window is generally circular.

3. A lamp assembly according to claim 1, wherein said output window is formed of zinc selenide.

4. A lamp assembly according to claim 1, wherein the lamp body is formed of one of (1) aluminum oxide, (2) ceramic, (3) material adapted to cooperate with the at least one ring and the sealant to provide vacuum-tight sealing.

5. A lamp assembly according to claim 1, wherein the at least one ring is adapted to flex between the lamp body and the output window.

6. A lamp assembly according to claim 1, wherein said at least one ring is solid and non-flexible.

7. A lamp assembly according to claim 1, wherein said at least one ring is formed of one of (1) Kovar, (2) Invar, (3) Invar alloy, (4) a metal alloy having a coefficient of thermal expansion between those of the output window and the lamp body material.

8. A lamp assembly according to claim 5, wherein the at least one ring is adapted to flex between the lamp body and the output window.

9. A lamp assembly according to claim 5, wherein said at least one ring is solid and non-flexible.

10. A lamp assembly according to claim 9, wherein the lamp body is formed of (1) alumina, (2) ceramic.

11. A lamp assembly according to claim 1, wherein said sealant between the ring and the output window and between the ring and the lamp body comprises one of (1) solder, (2) braze, (3) glass frit, (4) epoxy.

12. A lamp assembly according to claim 1, wherein said output window edge portion is metallized for securement thereto of the ring by a sealant which comprises one of (1) solder, (2) braze.

13. A lamp assembly according to claim 11, wherein said output window edge portion is metallized for securement thereto of the ring by a sealant which comprises one of (1) solder, (2) braze.

14. A lamp assembly according to claim 1, wherein the end portion of the lamp body is metallized for securement thereto of the ring by a sealant which comprises one of (1) solder, (2) braze.

15. A lamp assembly according to claim 12, wherein the end portion of the lamp body is metallized for securement thereto of the ring by a sealant which comprises one of (1) solder, (2) braze.

16. A lamp assembly according to claim 6, wherein:
said ring is generally cylindrical,
a flange extends radially of the ring and is adapted for securement by the sealant to an edge portion of the output window, and
a second flange extends radially of the ring and is spaced from the first flange for securement by the sealant to the lamp body end portion.

17. A lamp assembly having a lamp body and an output window with different coefficients of thermal expansion and contraction, said lamp assembly comprising:
a ring secured between an end portion of the lamp body and a peripheral portion of the output window,
a lamp body formed of one of (1) alumina, (2) ceramic,
an output window formed of zinc selenide,
an output window edge portion metallized for securement thereto of the ring by a sealant which comprises one of (1) solder, (2) braze, (3) glass frit, and
an end portion of the lamp body being metallized for securement thereto of the ring by a sealant which comprises one of (1) solder, (2) braze, (3) glass frit.

18. A lamp assembly according to claim 17, wherein said ring is formed of one of (1) Kovar, (2) Invar, (3) Invar alloy, (4) a metal alloy having a coefficient of thermal expansion between those of the output window and the lamp body material.

19. A lamp assembly according to claim 17, wherein said ring is solid and non-flexible.
